(19) United States
(12) Patent Application Publication
(10) Pub. No.: US 2011/0242574 A1
(43) Pub. Date: Oct. 6, 2011

(54) HARDCOPY DOCUMENT INTEGRITY

(75) Inventors: Randy Cruz Soriano, San Leandro, CA (US); Kenneth Huang Young, Foster City, CA (US); Isao Hayami, Kanagawa (JP)

(73) Assignee: KONICA MINOLTA SYSTEMS LABORATORY INC., Huntington Beach, CA (US)

(21) Appl. No.: 12/752,013

(22) Filed: Mar. 31, 2010

(51) Int. Cl. G06K 15/02

(52) U.S. Cl. 358/1.14

(57) ABSTRACT

A method for restricting duplication of a hardcopy document, including: displaying, in response to a request to print a document from a user application, a graphical user interface (GUI); receiving, in response to displaying the GUI, a plurality of print settings and a plurality of copy restrictions selected from the GUI by a user; generating a copy code by encoding the plurality of copy restrictions; generating a print job for the document based on the copy code and the plurality of print settings; and sending the print job to a print queue to generate the hardcopy document, where the hardcopy document includes a machine-readable version of the copy code, and where the copy code restricts duplication of the hardcopy document by a copier after the copier identifies the machine-readable version of the copy code on the hardcopy document.

### BACKGROUND

Photocopying technology is widely used in business, government, and education. Photocopying allows paper duplication of hardcopy documents, and represents a simple method for transferring information. Many modern day photocopiers utilize the electrophotographic process.

Photocopiers provide users with a wide array of settings for modifying and/or transmitting the content of the hardcopy document being copied. For example, photocopiers allow duplication in color, duplication in black and white, scaling of content, single-sided printing, duplex printing, emailing, and so forth. The user of a photocopier has complete control over how to modify the content of the original hardcopy document in the duplicate according to these settings.

### SUMMARY

In general, in one aspect, the invention relates to a method for restricting duplication of a hardcopy document. The method comprises: displaying, in response to a request to print a document from a user application, a graphical user interface (GUI); receiving, in response to displaying the GUI, a plurality of print settings and a plurality of copy restrictions selected from the GUI by a user; generating a copy code by encoding the plurality of copy restrictions; generating a print job for the document based on the copy code and the plurality of print settings; and sending the print job to a print queue to generate the hardcopy document, wherein the hardcopy document comprises a machine-readable version of the copy code, and wherein the copy code restricts duplication of the hardcopy document by a copier after the copier identifies the machine-readable version of the copy code on the hardcopy document.

In general, in one aspect, the invention relates to a computer readable storage medium storing instructions for restricting duplication of a hardcopy document. The instructions comprise functionality to: display, in response to a request to print a document from a user application, a graphical user interface (GUI); receive, in response to displaying the GUI, a plurality of print settings and a plurality of copy restrictions selected from the GUI by a user; generate a copy code by encoding the plurality of copy restrictions; generate a print job for the document based on the copy code and the plurality of print settings; and send the print job to a print queue to generate the hardcopy document, wherein the hardcopy document comprises a machine-readable version of the copy code, and wherein the copy code restricts duplication of the hardcopy document by a copier after the copier identifies the machine-readable version of the copy code on the hardcopy document.

In general, in one aspect, the invention relates to a method for restricting duplication of a hardcopy document. The method comprises: scanning, by a copier, the hardcopy document comprising a machine-readable version of a copy code; decoding a plurality of copy restrictions from the copy code, wherein the plurality of copy restrictions are selected by a user prior to generation of the hardcopy document; disabling a plurality of features of the copier based on the plurality of copy restrictions; and generating a duplication of the hardcopy document after disabling the plurality of features.

In general, in one aspect, the invention relates to a system for restricting duplication of a hardcopy document. The system comprises: a copy code generator configured with functionality to generate a copy code by encoding a plurality of copy restrictions, wherein the plurality of copy restrictions are selected by a user before generation of the hardcopy document; a page description language (PDL) generator operatively connected to the copy code generator and configured with functionality to generate a print job for a document and based on the copy code; and a printer operatively connected to the PDL generator and configured with functionality to generate the hardcopy document comprising a machine-readable version of the copy code, wherein the copy code restricts duplication of the hardcopy document by a copier after the copier identifies the machine-readable version of the copy code on the hardcopy document.

Other aspects of the invention will be apparent from the following description and the appended claims.

### BRIEF DESCRIPTION OF DRAWINGS

FIG. 1 shows a flow diagram of a system in accordance with one or more embodiments of the invention.

FIGS. 2 and 3 show flowcharts in accordance with one or more embodiments of the invention.

FIGS. 4 and 5 show flow diagrams of examples in accordance with one or more embodiments of the invention.

FIG. 6 shows a flow diagram of a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a system and method for restricting duplication of a hardcopy document. Specifically, in one or more embodiments of the invention, the system and method provide for a set of copy restrictions associated with a hardcopy document that restrict how duplication of the hardcopy document may occur. Further, in one or more embodiments of the invention, a machine-readable copy code based on the copy restrictions may be imprinted on the hardcopy document to enforce the restrictions when duplicating the hardcopy document via scanning and copying.

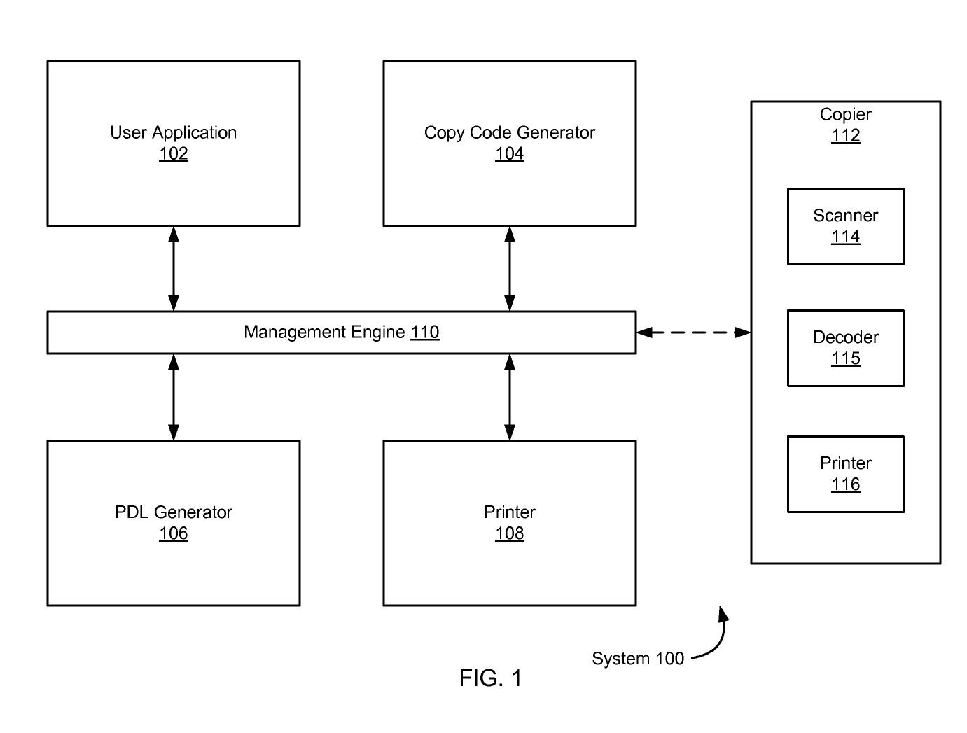

FIG. 1 shows a system (100) in accordance with one or more embodiments of the invention. As shown in FIG. 1, system (100) includes components such as user application (102), copy code generator (104), PDL generator (106), printer (108), management engine (110), and copier (112). These components are described below and may be located on the same device (e.g. a server, mainframe, desktop Personal Computer (PC), laptop, Personal Digital Assistant (PDA), telephone, mobile phone, kiosk, cable box, and any other device) or may be located on separate devices connected by a network (e.g. the Internet), with wired and/or wireless segments. In one or more embodiments of the invention, there may be more than one user application, copy code generator, PDL generator, and management engine running on a device, as well as more than one printer or copier interfacing with those components.

In one or more embodiments of the invention, user application (102) allows creation and editing of a document. Those skilled in the art will appreciate that user application (102) may create various documents and document types (i.e. text documents, spreadsheets, presentations, images) on a host computer. Documents created and/or edited in user application (102) may be referred to as softcopies in electronic form (as opposed to printed hardcopies). User application (102) includes functionality to initiate the printing process for a document based on print settings, as well as to associate copy restrictions with a document via copy settings. The print settings and copy settings may be selected by a user of user application (102). The term ‘copy settings’ may also be referred to as ‘copy options’ or ‘copy restrictions’. The print settings and copy settings may be invoked through the graphical user interface (GUI) of user application (102) and/or a print driver of printer (108), when a user prints a document. When the copy options are invoked in the GUI, a copy options dialogue box may display a list of possible copy restrictions that a user may select to restrict future duplication of the document.

In one or more embodiments of the invention, copy code generator (104) translates the list of user selected copy options into a copy code. The copy code may be generated in various forms, including but not limited to a barcode, a data glyph, a radio-frequency identification (RFID) tag, plaintext, or other machine-readable representations of the copy code. Those skilled in the art will appreciate that a data glyph is a method for encoding data by use of repeating glyph elements. For example, each glyph element of a data glyph may be made up of a 45 degree diagonal line measuring down to 0.001 of an inch. Each glyph element may represent a binary 0 or 1, depending on its slope (i.e. left or right). Sets of glyphs may be used to encode data in an inconspicuous element on the document. Glyph elements may make up a larger data glyph in the shape of a graphic design element (e.g. a picture, symbol, stylized character).

In one or more embodiments of the invention, PDL generator (106) packages the copy code for the printer (e.g., printer (108)). Accordingly, the PDL generator (106) may correspond to a printer driver. Those skilled in the art will appreciate that PDL is an acronym that stands for ‘page descriptor language’. Examples of PDLs include printer command language (PCL) by Hewlett Packard Company located in Palo Alto, Calif.; PostScript (PS) by Adobe Systems Inc. located in San Jose, Calif.; and XML Paper Specification (XPS) by Microsoft Inc. located in Redmond, Wash. If the print job is a PCL job or PS job, then PDL generator (106) generates various print objects and commands based on the document, as well as at least one print object representing the copy code value encoded in a form of a barcode, data glyph, an RFID chip, plaintext, or other appropriate data representation. The print object of the encoded copy code value can be added in the print job in either form of a text object, an image object or a graphics object. Once PDL generator (106) packages the encoded copy code as a print object, a print job for the document and including the PDL command is sent to the printer of the host computer. Alternatively, in the case of raster printing, the PDL Generator (106) may rasterize the copy code as a barcode, plaintext, data glyph, etc. and send the rasterized image data to the printer for printing.

In one or more embodiments of the invention, printer (108) receives the print job sent by PDL generator (106), and prints the document specified by the print job. Printer (108) may also print a barcode or data glyph including the copy code based on the PDL command. In one or more embodiments of the invention, printer (108) may store the copy code in an RFID chip. The RFID chip may be a label on the printed document and/or the RFID chip may be embedded within the printed document. Printer (108) may also be associated with a print queue that stores incoming print jobs for processing by printer (108). Printer (108) may also include functionalities required to read an encoded copy code, such as an RFID reader.

In one or more embodiments of the invention, the management engine (110) provides a link between the user application (102), copy code generator (104), PDL generator (106), printer (108), management engine (110), and copier (112). The management engine (110) may be configured to convert data or commands/messages from one format to another format in order to render the components (102, 104, 106, 108, 110, 112) compatible with each other. In one or more embodiments of the invention, the management engine (110) includes a GUI (not shown) for viewing one or more of the inputs and outputs of the components (102, 104, 106, 108, 110, 112).

In one or more embodiments of the invention, copier (112) scans and copies hardcopies of documents in accordance with one or more embodiments of the invention. Copier (112) may include subcomponents including scanner (114), decoder (115), and printer (116). Scanner (114) performs the scanning of a hardcopy document (i.e. reading and translation of the data in the document to digital form). If the copy code of the document is in an RFID format, then copier (112) will also include an RFID reader. Decoder (115) performs the decoding of the scanned image of the document, as well as the decoding of the copy code of the document. Therefore, after decoding, the copy restrictions encoded in the copy code will be enforced. After decoding, printer (116) performs the actual printing of the hardcopy document, enforcing the copy restrictions encoded in the document. Printer (116) may include an image buffer to hold the image of the document to be printed. Further, those skilled in the art will appreciate that printer (108) and copier (112) may include similar functionality, may also be referred to as a ‘multi-function device’ or ‘multi-function scanner’. The dotted line of FIG. 1 indicates that copier (112) might or might not be connected to management engine (110) (and the rest of system (100)) directly.

In one or more embodiments of the invention, insertion of a copy code into a hardcopy document ensures that the intent of a user that generated the document is followed when duplication is performed. For example, if a legal document is in duplex format (i.e. two-sided), the creator of the legal document may wish to require that any duplicates of the original document are also two-sided, in order to avoid loss of information during the copy process (i.e. if a single-sided copy was performed). Also, if the creator of a document wishes to save color ink or toner, a black and white only requirement may be placed on duplicates. Scaling may also be restricted as some print quality sensitive documents including images lose their image resolution when a copied version has been enlarged (i.e. rescaled). Furthermore, tagging information including barcodes and data glyphs may become unreadable when enlarged. Another example of when restriction of duplication may be useful is when a single sided document includes chapter separators, which may inadvertently be copied to the back side of a page in a two-sided duplicate. Those skilled in the art will appreciate that there are many other scenarios when enforcement of copy restrictions may be useful.

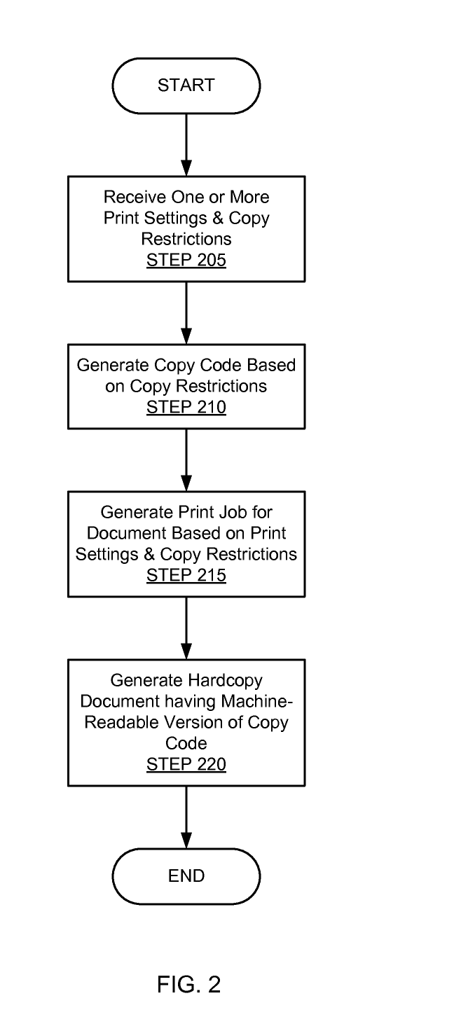

FIG. 2 shows a flowchart in accordance with one or more embodiments of the invention. The process shown in FIG. 2 may be used, for example, with system (100) to restrict the copy settings of a hardcopy document. The sequence of steps shown in FIG. 2 may differ among embodiments of the invention, and that one or more of the steps may be optional.

In STEP 205, one or more print settings and copy restrictions are received in accordance with one or more embodiments of the invention. These settings may be received through the GUI of a user application or a printer driver, in response to a request to print a document in the user application. The print settings and copy restrictions may also be selected by a user of the user application. The print settings may specify how the document is to be printed (e.g. printer name, pages to print, number of copies, scaling, pages per sheet, paper size, other paper options, and the like). The copy restrictions (also known as ‘copy options’ or ‘copy settings’) may specify restrictions to be enforced when duplicating the document in the future (e.g. black and white only, color only, no scaling, single-sided only, duplex only). Those skilled in the art will appreciate that there exist various other printer options and copy restrictions not described.

In STEP 210, copy code is generated based on selected copy restrictions in accordance with one or more embodiments of the invention. The copy code may be generated by a copy code generator. The copy code may be generated in various formats. For example, the copy code may be calculated by identifying a numerical value corresponding to each of the selected copy restrictions, and subsequently summing the numerical values.

In STEP 215, a print job is generated for a document based on the print settings and copy restrictions in accordance with one or more embodiments of the invention. The print job may be generated by a PDL generator, and may be sent to a print queue of the printer receiving the print job. The print job may include information about the document to be printed as well as the copy code associated with the document. For more details about the print job, please refer to the description of the PDL generator.

In STEP 220, a hardcopy document having a machine-readable version of the copy code is generated in accordance with one or more embodiments of the invention. The machine-readable version of the copy code may be a barcode including the copy code, a data glyph including the copy code, a plaintext version of the copy code, and/or an RFID chip storing the copy code. The hardcopy document may be generated by a printer that has the ability to physically encode the copy settings in the hardcopy document. For example, if the copy code is stored in an RFID chip, then the printer generating the hardcopy document may have functionality to write the copy code to the RFID chip.

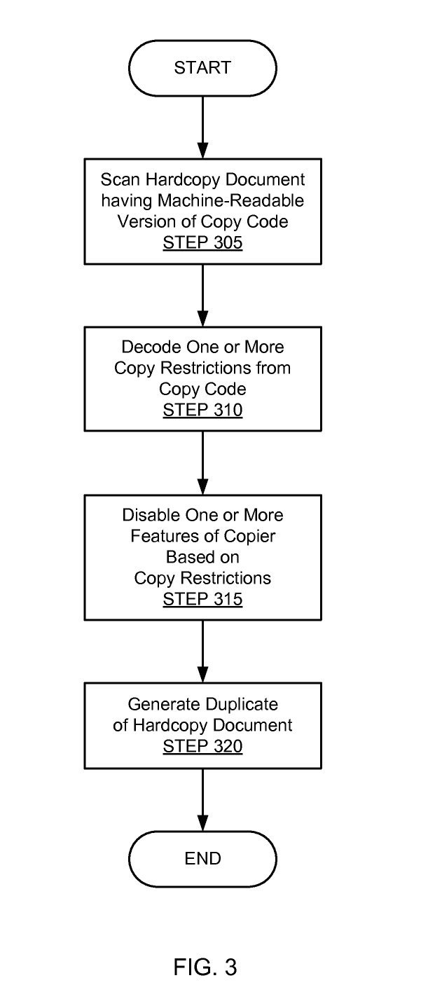

FIG. 3 shows a flowchart in accordance with one or more embodiments of the invention. The process shown in FIG. 3 may be used, for example, with system (100) to restrict scanning and copying of a hardcopy document. The sequence of steps shown in FIG. 3 may differ among embodiments of the invention, and that one or more of the steps may be optional.

In STEP 305, a hardcopy document having a machine-readable version of a copy code is scanned in accordance with one or more embodiments of the invention. The hardcopy document may be scanned by a scanner, or other multi-function device. The machine-readable version of the copy code may be a barcode including the copy code, a data glyph including the copy code, a plaintext version of the copy code, and/or an RFID chip storing the copy code. Accordingly, the scanner may include an RFID chip reader or interrogator.

In STEP 310, one or more copy restrictions are decoded from the copy code in accordance with one or more embodiments of the invention. The copy restrictions may be selected by a user prior to the generation of the hardcopy document. The copy restrictions may be encoded in various formats. For example, the copy code may include a set of digits, where each digit corresponds to a specific copy restriction (e.g. a binary code). The copy code may also be extracted (i.e. decoded) using various mechanisms. For example, in the scenario where the copy code is recorded in plaintext on the hardcopy document, the copy code may be extracted from the hardcopy document using optical character recognition (OCR).

In STEP 315, one or more features of a copier are disabled based on the copy restrictions in accordance with one or more embodiments of the invention. Those skilled in the art will appreciate that the copier may be part of the scanner. The features disabled based on the copy restrictions may include color copying, black and white (e.g. grayscale) coping, scaling, single-sided printing, duplex (i.e. two-sided) printing, and the like. Those skilled in the art will further appreciate that any copier used in this process will be required to possess functionality for decoding and implementing copy restrictions.

In STEP 320, a duplicate of the hardcopy document is generated in accordance with one or more embodiments of the invention. The duplicate may be generated by the copier portion of the scanner, and will adhere to the feature restrictions imposed by the copy restrictions. For example, if the features disabled by the copy code include color and scaling, then the duplicate of the hardcopy document will not be printed in color (even if the original hardcopy document was in color), and will not be scaled differently than the original hardcopy document. The duplicate of the hardcopy document will also contain the copy code of the original hardcopy document, for enforcement of copy restrictions in the event that further scanning and copying of the document occur in the future.

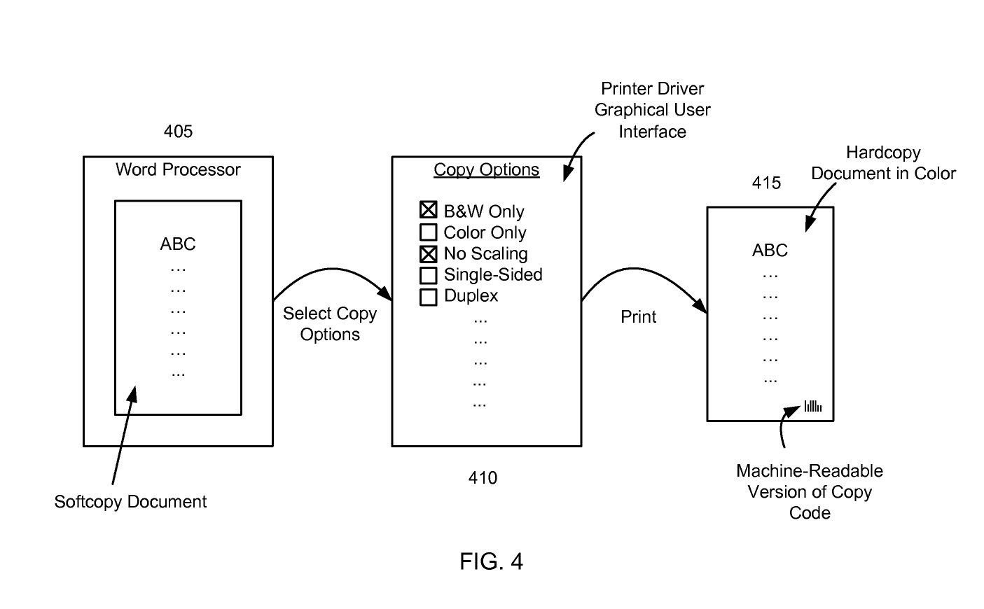

FIG. 4 shows an example in accordance with one or more embodiments of the invention. The example shown in FIG. 4 may be used, for example, with system (100) to restrict copy options associated with a printed hardcopy document. The sequence of steps shown in FIG. 4 may differ among embodiments of the invention, and that one or more of the steps may be optional.

Initially, a softcopy document is generated (see 405). The softcopy document may be generated by a word processor. Once the user issues a request to print the softcopy document, a printer driver GUI is displayed. The printer driver GUI includes a variety of print settings (e.g., number of copies, page selection, etc.) for selection by the user. In addition, the printer driver GUI may also include a variety of copy options (also known as ‘copy restrictions’ or ‘copy settings’) for restricting future duplication of the document. Similar to the print settings, the copy options are available for selection by the user. The print settings and the copy options may be displayed simultaneously within the GUI. Alternatively, the user may need to select a GUI widget (e.g., button, tab, radio button, etc.) in order to view and/or select the copy options. The copy options may include black and white (B&W) only, color only, no scaling, single-sided, duplex, and so forth. Those skilled in the art will appreciate that there will be many other copy options available for selection by the user.

Then, copy options are selected (see 410). The copy options may be selected by the user of the word processor via the GUI. In FIG. 4, the user has selected “B&W only” and “no scaling” as copy options. These restrictions require that future copying of the hardcopy document be performed in black and white only, and without scaling deviating from the dimensions of the hardcopy document. Once the user makes these selections, the copy options are encoded into a copy code.

Finally, a hardcopy version of the document is printed in color (see 415). The hardcopy version of the document may be printed by the user of the word processor using a printer. The printer may be, for example, printer (108), or a printer with similar functionality. The hardcopy version generated by the printer will be essentially identical to the softcopy document, except that the hardcopy version will include the copy code in machine-readable form. For example, in FIG. 4, the copy code is displayed as a barcode at the bottom right corner of the hardcopy document. This barcode will be readable by any compliant scanner/copier, so that when the hardcopy is scanned and copied in the future, the encoded copy restrictions are enforced by the scanner/copier.

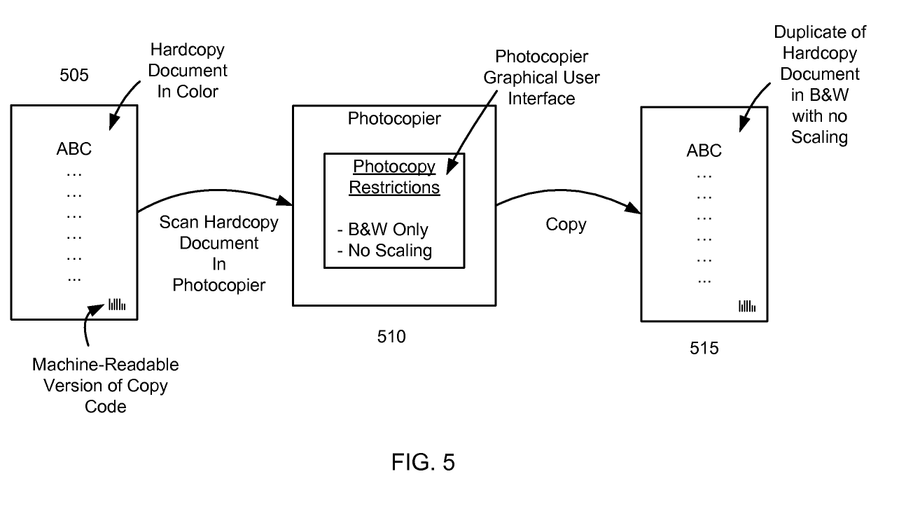

FIG. 5 shows an example in accordance with one or more embodiments of the invention. The example shown in FIG. 5 may be used, for example, with system (100) to scan and copy a hardcopy document with copy restrictions. The sequence of steps shown in FIG. 5 may differ among embodiments of the invention, and that one or more of the steps may be optional.

Initially, there exists a hardcopy version of a document (see 505). The hardcopy document is a color document, and includes copy settings (and hence copy code) in a machine-readable format in accordance with one or more embodiments of the invention. In FIG. 5, the copy settings are encoded into a barcode at the bottom right corner of the first page of the hardcopy document. Those skilled in the art will appreciate that the copy code is not restricted to the bottom right hand corner of the first page of the hardcopy document. The copy code could be, for instance, at any other location on each page of the hardcopy document (e.g. on the first page only, on every page, on the last page, on even pages, on the top left hand corner of pages, along the top of the page, in the middle of the content of the page, and the like). For example, copy code could be placed ‘within’ or ‘behind’ an image or text of a document. Further, in one or more embodiments of the invention, the copy code may be encoded as part of the text to be read by copiers that understand such a protocol. Further, those skilled in the art will appreciate that the copy settings may also be encoded into other machine-readable formats, such as RFID or data glyph.

Subsequently, the hardcopy document is scanned in a photocopier (see 510). During the scanning process, copy code is extracted from the hardcopy document and decoded. As discussed above, the copy code corresponds to one or more restrictions placed on future duplications of the hardcopy document. Accordingly, once the restrictions are identified (i.e., decoded) from the copy code, any feature of the photocopier restricted by the copy code is disabled. For example, the “B&W only” restriction disables the color copy feature of the photocopier. Similarly, the “no scaling” restriction disables the enlargement and reduction features of the photocopier. Therefore, any copy (i.e. duplicate) that the photocopier generates of the hardcopy document will be in black and white only, and will not have any scaling.

Finally, the hardcopy document is duplicated (i.e. copied) by the scanner/copier (see 515). The duplicate of the hardcopy document is itself a hardcopy document, in black and white, and without scaling in accordance with one or more embodiments of the invention. Beyond the black and white and scaling restrictions, the hardcopy document duplicate is identical to the original hardcopy document. The duplicate includes the machine-readable version of the copy code at the same location as the original hardcopy document. This way, future copying of the duplicate will also enforce the copy restrictions encoded in the copy code.

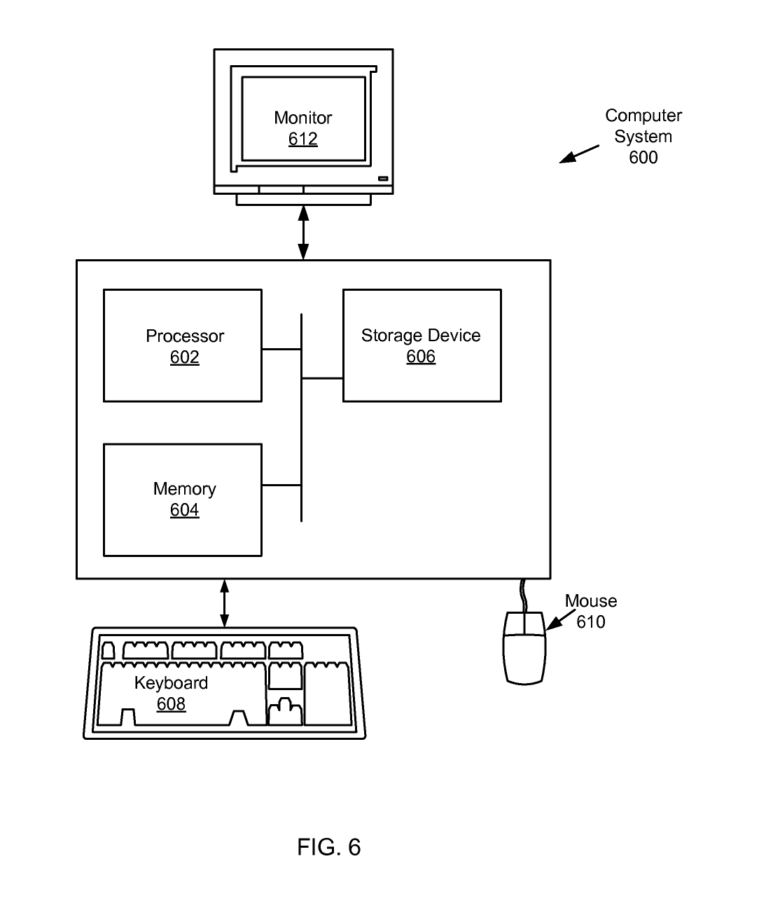

Embodiments of the invention may be implemented on virtually any type of computer regardless of the platform being used. For example, as shown in FIG. 6, a computer system (600) includes one or more processor(s) (602) (such as a central processing unit (CPU), integrated circuit, etc.), associated memory (604) (e.g. random access memory (RAM), cache memory, flash memory, etc.), a storage device (606) (e.g. a hard disk, an optical drive such as a compact disk drive or digital video disk (DVD) drive, a flash memory stick, etc.), and numerous other elements and functionalities typical of today's computers (not shown). The computer system (600) may also include input means, such as a keyboard (608), a mouse (610), or a microphone (not shown). Further, the computer system (600) may include output means, such as a monitor (612) (e.g. a liquid crystal display (LCD), a plasma display, or cathode ray tube (CRT) monitor). The computer system (600) may be connected to a network (not shown) (e.g. a local area network (LAN), a wide area network (WAN), the Internet, or any other type of network) via a network interface connection (not shown). Those skilled in the art will appreciate that many different types of computer systems exist, and the aforementioned input and output means may take other forms. Generally speaking, the computer system (600) includes at least the minimal processing, input, and/or output means necessary to practice embodiments of the invention.

Further, in one or more embodiments of the invention, one or more elements of the aforementioned computer system (600) may be located at a remote location and connected to the other elements over a network. Further, embodiments of the invention may be implemented on a distributed system having a plurality of nodes, where each portion of the invention (e.g. user application, copy code generator, PDL generator, printer, management engine, copier, etc.) may be located on a different node within the distributed system. In one embodiment of the invention, the node corresponds to a computer system. Alternatively, the node may correspond to a processor with associated physical memory. The node may alternatively correspond to a processor or micro-core of a processor with shared memory and/or resources. Further, software instructions in the form of computer readable program code to perform embodiments of the invention may be stored, temporarily or permanently, on a tangible computer readable storage medium, such as a compact disc (CD), a diskette, a tape, memory, or any other tangible computer readable storage device.

While the invention has been described with respect to a limited number of embodiments, those skilled in the art, having benefit of this disclosure, will appreciate that other embodiments may be devised which do not depart from the scope of the invention as disclosed herein. Accordingly, the scope of the invention should be limited only by the attached claims.

What is claimed is:

1. A method for restricting duplication of a hardcopy document, comprising:
displaying, in response to a request to print a document from a user application, a graphical user interface (GUI);
receiving, in response to displaying the GUI, a plurality of print settings and a plurality of copy restrictions selected from the GUI by a user;
generating a copy code by encoding the plurality of copy restrictions;
generating a print job for the document based on the copy code and the plurality of print settings; and
sending the print job to a print queue to generate the hardcopy document,
wherein the hardcopy document comprises a machine-readable version of the copy code, and
wherein the copy code restricts duplication of the hardcopy document by a copier after the copier identifies the machine-readable version of the copy code on the hardcopy document.

2. The method of claim 1, wherein the plurality of copy restrictions comprises a grayscale-only restriction.

3. The method of claim 1, wherein the plurality of copy restrictions comprises a no-scaling restriction.

4. The method of claim 1, wherein the plurality of print settings comprises a paper size.

5. The method of claim 1, wherein generating the copy code comprises:
identifying a plurality of numerical values corresponding to the plurality of copy restrictions; and
summing the plurality of numerical values to generate the copy code, wherein each of the plurality of numerical values is a power of two.

6. The method of claim 1, wherein the machine-readable version of the copy code comprises a data glyph.

7. The method of claim 1, wherein generating the print job comprises rasterizing the copy code.

8. The method of claim 1, wherein generating the print job comprises generating a print object representing the copy code.

9. The method of claim 1, wherein the machine-readable version of the copy code comprises a radio-frequency identification (RFID) label storing the copy code.

10. A computer readable storage medium storing instructions for restricting duplication of a hardcopy document, the instructions comprising functionality to:
display, in response to a request to print a document from a user application, a graphical user interface (GUI);
receive, in response to displaying the GUI, a plurality of print settings and a plurality of copy restrictions selected from the GUI by a user;
generate a copy code by encoding the plurality of copy restrictions;
generate a print job for the document based on the copy code and the plurality of print settings; and
send the print job to a print queue to generate the hardcopy document,
wherein the hardcopy document comprises a machine-readable version of the copy code, and
wherein the copy code restricts duplication of the hardcopy document by a copier after the copier identifies the machine-readable version of the copy code on the hardcopy document.

11. The computer readable storage medium of claim 10, wherein the plurality of copy restrictions comprises a no-scaling restriction.

12. The computer readable storage medium of claim 10, wherein the instructions to generate the copy code further comprise functionality to:
identify a plurality of numerical values corresponding to the copy restrictions; and
sum the plurality of numerical values to generate the copy code, wherein each of the plurality of numerical values is a power of two.

13. The computer readable storage medium of claim 10, wherein the machine-readable version of the copy code comprises a barcode.

14. A method for restricting duplication of a hardcopy document, comprising:
scanning, by a copier, the hardcopy document comprising a machine-readable version of a copy code;
decoding a plurality of copy restrictions from the copy code, wherein the plurality of copy restrictions are selected by a user prior to generation of the hardcopy document;
disabling a plurality of features of the copier based on the plurality of copy restrictions; and
generating a duplication of the hardcopy document after disabling the plurality of features.

15. The method of claim 14, wherein the copy code comprises a plurality of digits, and wherein each of the plurality of digits corresponds to a copy restriction of the plurality of copy restrictions.

16. The method of claim 14, further comprising:
extracting the copy code from the hardcopy document by performing optical character recognition (OCR), wherein the machine-readable version comprises plaintext.

17. The method of claim 14, further comprising:
reading the copy code from the hardcopy document using a radio-frequency identification (RFID) interrogator, wherein the hardcopy document comprises a RFID chip storing the copy code.

18. A system for restricting duplication of a hardcopy document, comprising:
a copy code generator configured with functionality to generate a copy code by encoding a plurality of copy restrictions, wherein the plurality of copy restrictions are selected by a user before generation of the hardcopy document;
a page description language (PDL) generator operatively connected to the copy code generator and configured with functionality to generate a print job for a document and based on the copy code; and
a printer operatively connected to the PDL generator and configured with functionality to generate the hardcopy document comprising a machine-readable version of the copy code,
wherein the copy code restricts duplication of the hardcopy document by a copier after the copier identifies the machine-readable version of the copy code on the hardcopy document.

19. The system of claim 18, further comprising:
a scanner configured with functionality to extract the copy code from the hardcopy document by reading the machine-readable version; and
a decoder operatively connected to the scanner and configured with functionality to identify the plurality of copy restrictions from the copy code extracted by the scanner,
wherein the copier comprises the scanner and the decoder, and
wherein the decoder is further configured to disable a plurality of features of the copier based on the plurality of copy restrictions.

20. The system of claim 18, wherein the machine-readable version of the copy code is a barcode.
